(19) United States
(12) Patent Application Publication
(10) Pub. No.: US 2026/0180420 A1
(43) Pub. Date: Jun. 25, 2026

(54) PHASE SHIFT PULSE WIDTH MODULATION CONTROLLER AND A CONTROL METHOD FOR AN INVERTER

(71) Applicant: HYUNDAI AUTOEVER CORP., Seoul (KR)

(72) Inventor: Eun Su Jun, Seoul (KR)

(73) Assignee: HYUNDAI AUTOEVER CORP., Seoul (KR)

(21) Appl. No.: 19/429,928

(22) Filed: Dec. 22, 2025

(30) Foreign Application Priority Data
Dec. 24, 2024 (KR) 10-2024-0195470

(51) Int. Cl. H02M 1/00; H02M 7/5395

(52) U.S. Cl. CPC H02M 1/0043; H02M 1/0012; H02M 7/5395

(57) ABSTRACT

An inverter controller includes a timer module including master output modules configured to output master Pulse Width Modulation (PWM) signals with a phase difference and PWM signal output modules configured to output a switching PWM signal of each phase in each control period, with the control period being synchronized with that of the master PWM signal of each phase. The inverter controller further includes a first core configured to calculate a switching PWM control value for each phase based on Analog-to-Digital Converter (ADC) sensing values for an inverter. The inverter controller further includes a second core configured to calculate register values for each phase based on the switching PWM control value for each phase and update registers of the PWM signal output modules based on the register values.

### CROSS REFERENCE TO RELATED APPLICATION

This application claims the benefit of and priority to Korea Patent Application No. 10-2024-0195470, filed on Dec. 24, 2024, the entire contents of which are incorporated herein by reference.

### TECHNICAL FIELD

The present disclosure relates to an inverter control technology.

### BACKGROUND

A device powered by a battery, such as an electric vehicle, may include an inverter for charging the battery.

The inverter can be used as a charger for the battery. In this case, the inverter serves to convert alternating current (AC) power supplied from an external power source into direct current (DC) power suitable for charging the battery.

The charger inverter may use high-efficiency semiconductor devices to reduce power loss. These may include not only silicon-based devices but also devices utilizing advanced materials, such as silicon carbide (SiC) or gallium nitride (GaN). Such devices enable high power density and heat management, contributing to the reduction in size and weight of the charger.

The alternating current (AC) power supplied to the inverter may be three-phase power. The three-phase power may refer to a form of electrical power in which three independent currents flow with a 120-degree phase difference relative to each other. This indicates that the AC power source can be designed to enable constant and balanced power transmission. As such, three-phase power is characterized by its ability to efficiently deliver high power while minimizing voltage fluctuations.

The inverter can receive and process such three-phase power and, in doing so, may utilize a phase-shifting technique. The phase-shifting technique can be defined as a method of optimizing output power by adjusting or compensating each of the three phases. This implies that the inverter is capable of accurately calculating phase differences in input power and, based on this, appropriately converting the current and voltage of each phase.

The phase-shifting technique can be implemented using switching elements and control circuits to improve power conversion efficiency within the inverter. This technique can help reduce power loss under specific operating conditions and minimize distortion in output waveform. Additionally, through phase shifting, the inverter may be designed to maintain stable output even under unbalanced load conditions.

An inverter that handles three-phase power can use a multi-phase circuit to independently control the voltage and current of each phase. In this process, switching frequency and current paths can be optimized to maintain the inverter's performance. Additionally, the phase-shifting technique can be utilized to adjust or distribute power flow according to specific load or power requirements.

An inverter controller can control switching elements placed in an inverter power stage using a switching PWM signal. The switching elements may be composed of semiconductor devices such as transistors, and the switching PWM signal is a signal for adjusting pulse width over a certain period to control the on and off states of the devices. Through this, the inverter controller performs the control operations necessary for efficient power conversion.

The switching PWM signal may include a pulse signal with a specific voltage and frequency, and this signal can be generated based on a control algorithm. By generating a switching PWM signal, the inverter controller actuates the switching elements in the inverter power stage, thereby converting input three-phase alternating current (AC) power into direct current (DC) power.

The inverter controller can phase-shift switching PWM signals of different phases individually in order to apply the phase-shifting technique. Phase shifting may refer to the process of moving the phase of a switching PWM signal by a specific angle, which allows for adjustment of the voltage and current of each phase. A phase-shifted PWM signal can be used to drive the switching devices for each phase in the power stage and to control the conversion of AC power of each phase into DC power.

Meanwhile, the switching PWM signals of different phases may be generated by PWM signal output modules. The PWM signal output modules can generate and output a switching PWM signal based on the values of registers. However, if the part that generates and updates the register values operates independently from the part that outputs the switching PWM signal based on the register values, issues may arise. Specifically, if one part of the inverter controller updates the register values while another part outputs the switching PWM signal based on the register values, data consistency may not be guaranteed, potentially leading to errors in the switching PWM signal. This issue is more likely to occur depending on the phase-shifting technique when the switching PWM signal of some phase is outputted with a delay.

The subject matter described in this background section is intended to promote an understanding of the background of the disclosure and thus may include subject matter that is not already known to those of ordinary skill in the art.

### SUMMARY

In one aspect, the present disclosure is directed to providing a technology that ensures that the inverter has data coherency. In another aspect, the present disclosure is directed to providing a technology that prevents errors in switching PWM signals in an inverter to which a phase-shifting technique is applied.

An embodiment of the present disclosure provides an inverter controller including a timer module including master output modules configured to output master Pulse Width Modulation (PWM) signals with a phase difference and PWM signal output modules configured to output a switching PWM signal of each phase in each control period, with the control period being synchronized with that of the master PWM signal of each phase. The inverter controller further includes a first core configured to calculate a switching PWM control value for each phase based on Analog-to-Digital Converter (ADC) sensing values for an inverter. The inverter controller further includes a second core configured to calculate register values for each phase based on the switching PWM control value for each phase and update registers of the PWM signal output modules based on the register values.

The PWM signal output module for each phase may include registers that respectively store a rising edge time value and falling edge time value of the switching PWM signal. The second core may calculate a rising edge time value and a falling edge time value based on the switching PWM control value for each phase.

The PWM signal output module for each phase may include a timer counter, a first register, and a second register. The rising edge time value is stored in the first register, and the falling edge time value is stored in the second register. The PWM signal output module for each phase may form a rising edge of the switching PWM signal when a value of the timer counter becomes equal to the value of the first register. The PWM signal output module for each phase may form a falling edge of the switching PWM signal when the value of the timer counter becomes equal to the value of the second register.

The timer counter of the PWM signal output module for each phase may be reset in synchronization with the master PWM signal of each phase.

The first register and the second register may be updated at a starting point of each phase's control period determined by either the timer counter or the master PWM signal.

The PWM signal output module for each phase may further include shadow registers (SR registers). The second core may store the rising edge time value and the falling edge time value in the SR registers. The values of the SR registers may be transferred to the first register and the second register at a starting point of each phase's control period.

Alternating current power with three phases may be supplied to the inverter, and the power of each phase may be controlled to have a 120-degree phase difference.

The first core may set a first flag before calculating the switching PWM control value for each phase and clear the first flag after the calculation. When calculating the register values for each phase, if the first flag is set, the second core may calculate the register values for each phase based on the switching PWM control value for each phase calculated in a previous control period.

The first core may store the calculated switching PWM control value for each phase in a variable for the calculated value from a previous period, after clearing the first flag. The second core may check the switching PWM control value calculated in the previous control period through the variable for the calculated value from the previous period.

The second core may set a second flag before calculating the register values for each phase and clear the second flag after the calculation. The first core may store the calculated switching PWM control value for each phase in a variable for the calculated value from a previous period after calculating the switching PWM control value for each phase. The first core may store the calculated switching PWM control value for each phase in the variable for the calculated value from the previous period when the second flag is cleared.

In an Interrupt Service Routine (ISR) of each phase invoked before a starting point of the control period for each phase, the second core may update the registers of the PWM signal output module for each phase.

In the ISR of one phase, after updating the registers of the PWM signal output module for that phase, the second core may set a third flag for that phase. When the third flag for that phase is set, the second core may perform the ISR of another phase with a phase difference.

The timer module may be implemented as a generic timer module (GTM), and the master output modules and the PWM signal output modules may be implemented as timer output modules (TOMs) positioned within the GTM.

The switching PWM control value may be a value that indicates a duty cycle of the switching PWM signal.

Another embodiment of the present disclosure provides a control method for an inverter. The control method includes calculating, by a first core, a switching Pulse Width Modulation (PWM) control value for each phase based on Analog-to-Digital Converter (ADC) sensing values for the inverter. The control method includes calculating, by a second core, register values for each phase based on the switching PWM control value for each phase. The control method includes updating, by the second core, registers of PWM signal output modules based on the register values. The control method includes outputting, by a first phase master output module, a first phase master PWM signal. The control method includes outputting, by a first phase PWM signal output module, a first phase switching PWM signal in each control period, with the control period being synchronized with that of the first phase master PWM signal. The control method includes outputting, by a second phase master output module, a second phase master PWM signal with a 120-degree phase difference. The control method includes outputting, by a second phase PWM signal output module, a second phase switching PWM signal in each control period, with the control period being synchronized with that of the second phase master PWM signal. The control method includes outputting, by a third phase master output module, a third phase master PWM signal with a 240-degree phase difference from the first phase master PWM signal. The control method includes outputting, by a third phase PWM signal output module, a third phase switching PWM signal in each control period, with the control period being synchronized with that of the third phase master PWM signal.

Calculating, by the first core, the switching PWM control value for each phase may include setting a first flag before calculating the switching PWM control value for each phase and clearing the first flag after the calculation. Calculating, by the second core, the register values for each phase includes, when calculating the register values for each phase, if the first flag is set, calculating the register values for each phase based on the switching PWM control value for each phase calculated in a previous control period.

The control method may further include storing, by the first core, the calculated switching PWM control value for each phase in a variable for the calculated value from a previous period, after clearing the first flag. The control method may further include checking, by the second core, the switching PWM control value calculated in the previous control period through the variable for the calculated value from the previous period.

Calculating, by the second core, the register values for each phase may include setting a second flag before calculating the register values for each phase and clearing the second flag after the calculation. Calculating, by the first core, the switching PWM control value for each phase may include storing the calculated switching PWM control value for each phase in the variable for the calculated value from a previous period after calculating the switching PWM control value for each phase. The first core may store the calculated switching PWM control value for each phase in the variable for the calculated value from the previous period when the second flag is cleared.

The PWM signal output module for each phase may include registers that respectively store a rising edge time value and falling edge time value of the switching PWM signal. Calculating, by the second core, the register values for each phase may include calculating a rising edge time value and a falling edge time value based on the switching PWM control value for each phase.

The PWM signal output module for each phase may include a timer counter, a first register, and a second register. The rising edge time value may be stored in the first register. The falling edge time value may be stored in the second register. The control method may further include forming, by the PWM signal output module for each phase, a rising edge of the switching PWM signal when a value of the timer counter becomes equal to a value of the first register. The control method may further include forming, by the PWM signal output module for each phase, a falling edge of the switching PWM signal when the value of the timer counter becomes equal to the value of the second register.

As described above, according to the present embodiment, the inverter can have data coherency. Furthermore, according to the present embodiment, it is possible to minimize the possibility of errors in switching PWM signals in an inverter to which a phase-shifting technique is applied.

### BRIEF DESCRIPTION OF THE DRAWINGS

FIG. 1 is a configuration diagram of an inverter according to an embodiment.

FIG. 2 is a configuration diagram of a power stage according to an embodiment.

FIG. 3 is a waveform diagram of switching Pulse Width Modulation (PWM) signals and currents of different phases according to an embodiment.

FIG. 4 is a configuration diagram of an inverter controller according to an embodiment.

FIG. 5 is a configuration diagram of a timer output module (TOM) according to an embodiment.

FIG. 6 is a diagram illustrating the generation of switching PWM signals for different phases without applying a phase-shifting technique.

FIG. 7 is a diagram illustrating the generation of switching PWM signals for different phases by applying a phase-shifting technique.

FIG. 8 is a diagram illustrating waveforms of a master PWM signal and switching PWM signal for the U phase according to one embodiment.

FIG. 9 is a diagram illustrating waveforms of a master PWM signal and switching PWM signal for the V phase according to one embodiment.

FIG. 10 is a diagram illustrating waveforms of a master PWM signal and switching PWM signal for the W phase according to one embodiment.

FIG. 11 is a first example diagram illustrating main waveforms of the inverter controller and the flow of an operational process of each core, according to one embodiment.

FIG. 12 is a second example diagram illustrating main waveforms of the inverter controller and the flow of an operational process of each core, according to one embodiment.

FIG. 13 is a flowchart illustrating an inverter control method according to one embodiment.

FIG. 14 is a detailed flowchart of step S1300 in the flowchart of FIG. 13.

FIG. 15 is a detailed flowchart of step S1301 in the flowchart of FIG. 13.

FIG. 16 is a detailed flowchart of step S1302 in the flowchart of FIG. 13.

### DETAILED DESCRIPTION

Hereinafter, certain embodiments of the present disclosure are described in detail with reference to drawings. It should be noted that, in assigning reference numerals to components in the drawings, the same components are given the same numerals as much as possible, even if they are shown in different drawings. Furthermore, in describing the present disclosure, detailed explanations of well-known components or functions may be omitted if they are deemed to obscure the gist of the disclosure.

In describing the components of the present disclosure, terms such as first, second, A, B, (a), (b), and the like may be used. These terms are merely intended to distinguish one component from another, and the essence, sequence, or order of the components are not limited by the terms. Furthermore, when a component is described as being “connected”, “coupled”, or “attached” to another component, it should be understood that the component may be directly connected or attached to another component or that the component may also be “connected”, “coupled”, or “attached” to another component via yet another component provided therebetween. When a controller, module, component, device, element, unit, part, portion, “-er,” or the like of the present disclosure is described as having a purpose or performing an operation, function, or the like, the controller, module, component, device, element, unit, part, portion, “-er,” or the like should be considered herein as being “configured to” meet that purpose or to perform that operation or function. Each controller, module, component, device, element, unit, part, portion, “-er,” and the like may separately embody or be included with a processor and a memory, such as a non-transitory computer readable media, as part of the apparatus.

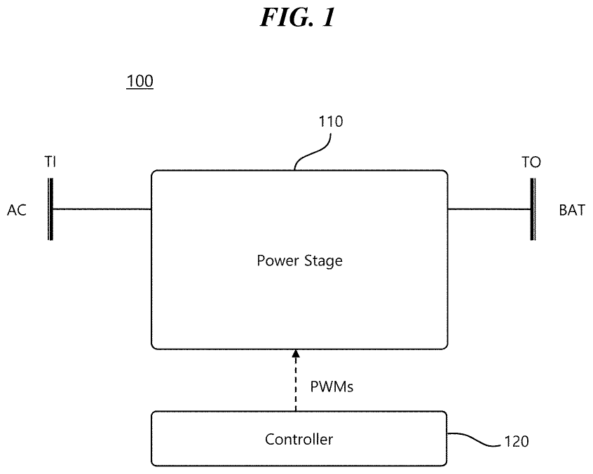

FIG. 1 is a configuration diagram of an inverter according to an embodiment.

Referring to FIG. 1, the inverter 100 may include a power stage 110 and an inverter controller 120.

The inverter 100 may function as a fast charger for an electric vehicle. In this case, alternating current (AC) power may be supplied to an input terminal (TI) of the inverter 100. The inverter 100 may then supply direct current (DC) power to an output terminal (TO). Then, a battery (BAT) may be connected to the output terminal (TO).

The alternating current (AC) power may be three-phase power. For convenience of explanation, the alternating current (AC) power is hereinafter described as having U-phase, V-phase, and W-phase electric power, but the present disclosure is not limited thereto.

The battery (BAT) may serve as a primary energy storage device of the electric vehicle, and lithium-ion-based battery cells may be primarily used. The battery (BAT) stores the power converted by the inverter 100, and the stored energy may be used to supply power to the electric vehicle's motor driving and other electronic devices. The battery (BAT) may be designed to repeat charging and discharging processes, and a battery management system (BMS) may also be used to monitor conditions such as temperature, voltage, and current.

A plurality of switches may be arranged in the power stage 110. These switches may include, for example, MOSFETS (Metal-Oxide-Semiconductor Field-Effect Transistors), IGBTs (Insulated Gate Bipolar Transistors), BJTs (Bipolar Junction Transistors), etc.

A MOSFET (Metal-Oxide-Semiconductor Field-Effect Transistor) is a device that can control the current between drain and source by applying the voltage between gate and source. The MOSFET may be a voltage-controlled device, and channel conductivity may be adjusted according to the voltage applied to the gate. The drain-source current is determined by the gate voltage, and due to their excellent switching characteristics, the MOSFET is widely used in switching applications.

An IGBT (Insulated Gate Bipolar Transistor) is a device that combines the characteristics of MOSFET and BJT, and it may control the collector-emitter current by applying a voltage between gate and emitter. The IGBT is capable of handling high voltages, and its structure may possess the input characteristics of MOSFET and the output characteristics of BJT. Due to this characteristic, the IGBT can be used in applications that require high power density.

A BJT (Bipolar Junction Transistor) is a device including three terminals: base, collector, and emitter, that controls the current between collector and emitter by applying a base current. The BJT is a current-controlled device, and the collector current may be amplified by the base current. Due to this amplification characteristic, the BJT can be used in current amplifiers and has the advantage of handling high current in specific applications.

The inverter controller 120 may control these switches using PWM (Pulse Width Modulation. Through this PWM control, the inverter controller 120 may control the duty cycle of each switch and control the switching period or switching frequency of each switch.

The inverter controller 120 may control the switches using a fixed-frequency method. In this case, each switch may be controlled at the same frequency. For convenience of explanation, the following description focuses on the inverter controller 120 controlling the switches using a fixed-frequency method. In this fixed-frequency method, the inverter controller 120 may primarily control the duty cycle of each switch.

PWM control may be a method of generating desired output voltage or current by adjusting the ON time and OFF time of the switches. Through this PWM control, the inverter controller 120 may adjust the duty cycle of each switch. The duty cycle represents the ratio of the time during which the switch is ON, and the duty cycle can be used to control the amplitude of the output power.

The inverter controller 120 may include a circuit or algorithm capable of monitoring input signals such as voltage, current, and temperature and generating PWM signals based on the input signals, in order to adjust the states of the switches in real time.

In a control period for each phase, the inverter controller 120 may perform processes such as a process of acquiring sensing values from an ADC (Analog-Digital Converter), a voltage control process, a current control process, a control value setting process, and a register configuration process.

The inverter controller 120 may include a plurality of ADC channels. Each ADC channel may sense the current of each phase, the voltage of a DC link capacitor, the voltage of an output node, etc. and may convert them into digital values. The inverter controller 120 may acquire sensing values from the individual ADC channels during an initial time segment of each control period.

The inverter controller 120 may perform voltage control based on the acquired ADC sensing values. For example, the inverter controller 120 may perform a voltage control process to execute a control algorithm designed to compare a sensed voltage value of the DC link capacitor with a reference voltage value and minimize the difference between the two values.

The inverter controller 120 may perform current control based on the ADC sensing values and the result values of the voltage control process. For example, the inverter controller 120 may perform a current control process to execute a control algorithm that uses the sensed current value of each phase and the result value calculated in the voltage control process to maintain the current value of each phase at a consistent level.

The inverter controller 120 may calculate control values for switching PWM signals for each switch—for example, duty cycles-based on the result values of the current control process, and store the calculated values in a predefined data variable.

The inverter controller 120 may read the values stored in the predefined data variable, calculate register values based on these values, and configure the registers with the calculated values. Then, based on the register values, the switching PWM signals (PWMs) may be sent to the switches of the power stage 110.

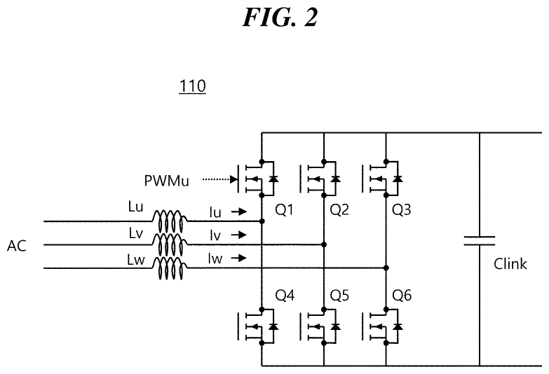

FIG. 2 is a configuration diagram of a power stage according to an embodiment.

Referring to FIG. 2, an input filter may be placed in the power stage 110. A first inductor Lu may be placed in the U phase, a second inductor Lv may be placed in the V phase, and a third inductor Lw may be placed in the W phase.

In the power stage 110, a pair of switches may be connected to each phase. A first switch Q1 and a fourth switch Q4 may be arranged in the U phase, a second switch Q2 and a fifth switch Q5 may be arranged in the V phase, and a third switch Q3 and a sixth switch Q6 may be arranged in the W phase.

The inverter controller may supply switching PWM signals to the gates of the switches Q1 to Q6 to control the ON/OFF of the switches Q1 to Q6. For example, the inverter controller may supply a switching PWM U-phase signal (PWMu) to the gate of the first switch Q1 to control the ON/OFF of the first switch Q1. The inverter controller may supply a switching PWM V-phase signal to the gate of the second switch Q2 to control the ON/OFF of the second switch Q2. The inverter controller may supply a switching PWM W-phase signal to the gate of the third switch Q3 to control the ON/OFF of the third switch Q3. For low-side switches in each arm forming a pair, an inverted signal of an upper-side switching PWM signal may be inputted, or a switching PWM signal whose ON period does not overlap with that of the upper-side switching PWM signal may be supplied.

Depending on the ON/OFF of each switch Q1 to Q6, the phase currents Iu, Iv, and Iw may be converted into direct current and temporarily stored in the DC link capacitor (Clink). For example, depending on the ON/OFF of the first to sixth switches Q1 to Q6, the phase currents Iu, Iv, and Iw of the power stage 110 may be converted into direct current and temporarily stored in the DC link capacitor (Clink).

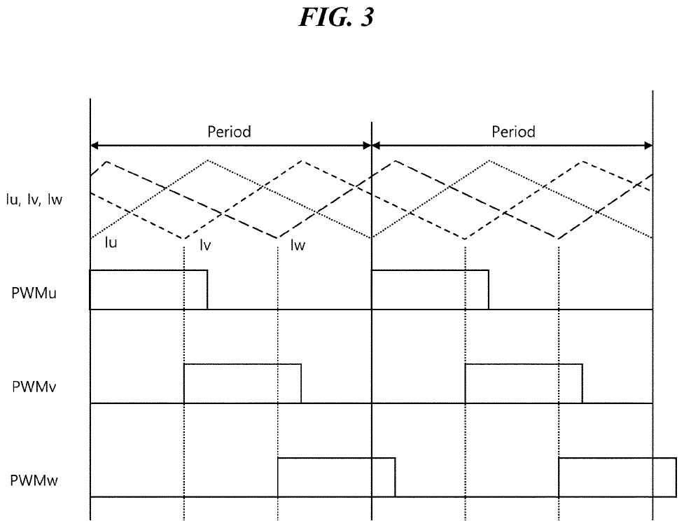

FIG. 3 is a waveform diagram of switching PWM signals and currents of different phases according to an embodiment.

Referring to FIG. 3, the waveform of the U-phase current Iu may be determined by the U-phase switching PWM signal (PWMu). The waveform of the V-phase current Iv may be determined by the V-phase switching PWM signal (PWMv), and the waveform of the W-phase current Iw may be determined by the W-phase switching PWM signal (PWMw).

The V-phase switching PWM signal (PWMv) may have a phase difference of 120 degrees from the U-phase switching PWM signal (PWMu). The W-phase switching PWM signal (PWMw) may have a phase difference of 120 degrees from the V-phase switching PWM signal (PWMv). The U-phase switching PWM signal (PWMu) may have a phase difference of 120 degrees from the W-phase switching PWM signal (PWMw).

The inverter controller according to an embodiment may control the switching PWM signal of each phase to have a constant phase difference.

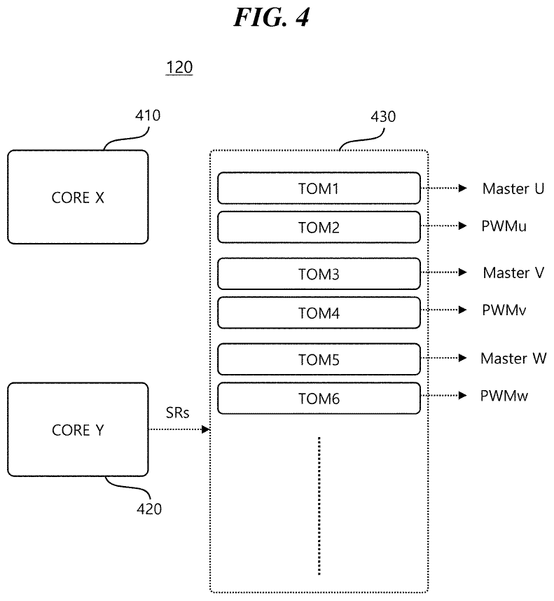

FIG. 4 is a configuration diagram of an inverter controller according to an embodiment.

Referring to FIG. 4, the inverter controller 120 may include a first core 410, a second core 420, and a timer module 430.

The inverter controller 120 may be configured in the form of an MCU (Micro-Controller Unit).

The MCU (Micro-Controller Unit) is an integrated circuit for an embedded system that may include one or more processor cores. These cores may have a structure capable of performing 8-bit, 16-bit, 32-bit, or higher bit data processing. Depending on the requirements of a specific application, the MCU may be designed to include multiple 32-bit cores. Such a design may offer the potential for parallel processing and high-performance computational tasks.

The MCU may be configured as a hardware and software platform for use in automotive and industrial applications. The MCU may function in environments that require high-performance computation, communication, and data processing. Through this, the MCU may be used to control various sensors and actuators and to execute complex control algorithms. The MCU may contribute to enhancing system stability and efficiency by generating control signals or processing data.

The MCU may support functional safety at the ISO 26262 ASIL-D (Automotive Safety Integrity Level-D) level. This standard defines the requirements necessary to ensure safe operation in automotive applications. In accordance with these requirements, the MCU may include fault diagnosis, error detection, and recovery functions. Through this, it is possible to meet the hardware and software design elements needed to enhance the safety of automotive systems.

The MCU may comply with the AUTOSAR (Automotive Open System Architecture) 4.2 standard. This standard defines the software architecture of automotive electronic control units (ECUs), and the MCU may perform integrated functions within this architecture. By complying with AUTOSAR, the MCU may provide a software platform that ensures interoperability among various suppliers and systems.

The MCU may include communication interfaces, data processing capability, and security features. The communication interfaces may include CAN (Controller Area Network), LIN (Local Interconnect Network), FlexRay, and Ethernet, through which the MCU can exchange data with an external device. The data processing capability may vary depending on the performance of the cores included in the MCU and the memory size. Additionally, the MCU may provide hardware security features such as an encryption module or security authentication.

The MCU may perform sensor data collection and processing and actuator control through various input and output interfaces. This enables the MCU to support conversion tasks between the physical world and digital signals. Additionally, the MCU may include functions such as ADC (Analog-to-Digital Converter), DAC (Digital-to-Analog Converter), and PWM (Pulse Width Modulation), allowing for various control and conversion tasks.

The MCU may include built-in memory and storage. Program code and data may be stored using embedded flash memory or EEPROM (Electrically Erasable Programmable Read-Only Memory), and RAM (Random Access Memory) may be included to process data required during execution. This memory architecture may be designed in various ways to meet the requirements of the application.

The first core 410 and the second core 420 may be one of the multiple cores included in the MCU.

The first core 410 may calculate a switching PWM control value for each phase based on an ADC (Analog-to-Digital Converter) sensing value for the inverter. The switching PWM control value for each phase may be a value that indicates the duty cycle of each switching PWM signal.

The first core 410 may acquire ADC sensing values for the inverter in each control period, and may perform voltage control and current control processes for the inverter to calculate the switching PWM control value for each of the switches in the inverter. The first core 410 may then store the calculated switching PWM control values in a data variable.

The second core 420 may calculate register values for each phase based on the switching PWM control value for each phase, and may update the registers of the PWM signal output modules based on the calculated register values.

The register values may include, for example, a rising edge time value and falling edge time value of a switching PWM signal. The second core 420 may calculate the rising edge time value and falling edge time value based on the switching PWM control value for each phase. If a control period value is defined as a timer's base unit of time (e.g., tick) and the switching PWM control value is a duty cycle value, the second core 420 may apply the duty cycle value to the control period value to calculate the rising edge time (whose unit is the timer's base unit of time) and the falling edge time value. The PWM signal output module for each phase may include a register for storing the rising edge time value of the switching PWM signal (e.g., CM0 (Compare Match Register 0)) and a register for storing the falling edge time value (e.g., CM1 register), and the register values calculated by the second core 420 may ultimately be applied to these registers.

The timer module 430 may have the form of a GTM (Generic Timer Module).

The GTM may be a hardware module capable of performing complex timing and event control tasks in embedded systems. This module may include various channels and can be used in applications that require precise time-based control. The GTM may provide hardware-based timing management functions that support tasks such as input signal processing, output signal generation, and timing control.

The GTM may include submodules. These submodules may include sub-structures such as TOM (Timer Output Module), ATOM (Advanced Timer Output Module), TIM (Timer Input Module), and TBU (Time Base Unit). TOM is a module that supports PWM (Pulse Width Modulation) signal generation, and may be designed to allow independent control for each channel. ATOM is a timing control module that can provide higher precision and flexibility than TOM. TIM may process input signals to detect timing events or capture time data. TBU provides a time base that serves as a reference for timer operation.

The GTM may include an integrated clock management mechanism. A Clock Management Unit (CMU) may provide clock signals suitable for each submodule of the module, and may control the frequency and accuracy of the timer. Through this, the GTM may support operations suitable for various timing requirements.

The GTM may support multi-channel operation. This allows the timer module 430 to process multiple input and output signals simultaneously, with each channel being independently configured and controlled.

The timer module 840 may include a plurality of TOMs (TOM1, TOM2, TOM3, TOM4, TOM5, TOM6, . . . ). Some TOMs (TOM1, TOM3, TOM5) may operate as master output modules which output master PWM signals (Master U, Master V, Master W), while other TOMs (TOM2, TOM4, TOM6) may operate as PWM signal output modules which output switching PWM signals.

For example, the first TOM (TOM1) may operate as a U-phase master output module which outputs a U-phase master PWM signal (Master U); the third TOM (TOM3) may operate as a V-phase master output module, which outputs a V-phase master PWM signal (Master V); and the fifth TOM (TOM5) may operate as a W-phase master output module, which outputs a W-phase master PWM signal (Master W). The second TOM (TOM2) may operate as a U-phase PWM signal output module, which outputs a U-phase switching PWM signal (PWMu); the fourth TOM (TOM4) may operate as a V-phase PWM signal output module, which outputs a V-phase switching PWM signal (PWMv); and the sixth TOM (TOM6) may operate as a W-phase PWM signal output module, which outputs a W-phase switching PWM signal (PWMw).

The master output modules (TOM1, TOM3, TOM5) may output master PWM signals (Master U, Master V, Master W) with a phase difference. For example, the V-phase master PWM signal (Master V) may have a phase delay of 120 degrees relative to the U-phase master PWM signal (Master U). Furthermore, the W-phase master PWM signal (Master W) may have a phase delay of 120 degrees relative to the V-phase master PWM signal (Master V) and a phase delay of 240 degrees relative to the U-phase master PWM signal (Master U).

The PWM signal output modules (TOM2, TOM4, TOM6) may output a switching PWM signal of each phase in each control period, with the control period being synchronized with that of the master PWM signal of each phase. For example, the U-phase PWM signal output module (TOM2) may output the U-phase switching PWM signal (PWMu) in each control period, with the control period being synchronize with that of the U-phase master PWM signal (Master U). The V-phase PWM signal output module (TOM4) may output the V-phase switching PWM signal (PWMv) in each control period, with the control period being synchronized with that of the V-phase master PWM signal (Master V). The W-phase PWM signal output module (TOM6) may output the W-phase switching PWM signal (PWMw) in each control period, with the control period being synchronized with that of the W-phase master PWM signal (Master W).

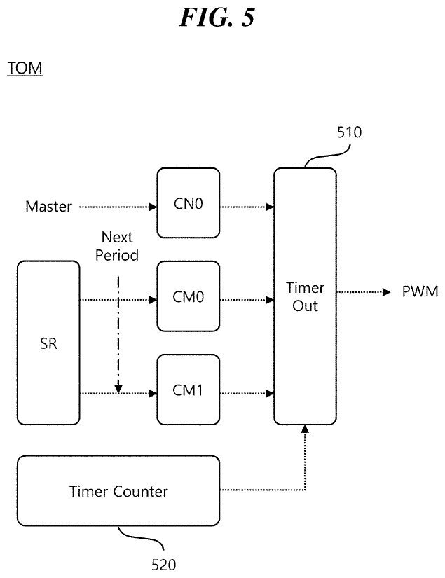

FIG. 5 is a configuration diagram of a TOM according to an embodiment.

Referring to FIG. 5, the TOM may include registers such as a shadow register (SR), a 1CN register (CN0: Compare Number Register 0), a 1CM register (CM0: Compare Match Register 0), and a 2CM register (CM1: Compare Match Register 1). The TOM may perform timer-based signal processing through these registers. Each register may perform a specific function in the process of generating or outputting a PWM (Pulse Width Modulation) signal.

The shadow register (SR) may be used as a space for temporarily storing values during operation. It helps prevent immediate impact on timer output when the register values are changed, and provides a structure that allows new values to be applied reliably. This allows for a design that contributes to maintaining signal continuity and stability in the process of generating PWM signals.

The second core may calculate register values and update the register values into the shadow registers (SR). The values stored in the shadow registers (SR) may then be transferred to other registers, for example, the 1CM register (CM0) and the 2CM register (CM1), at the starting point of a control period (next period).

The 1CN register (CN0) may be configured as a register for comparing the current value of a timer counter 520. The 1CN register (CN0) may be used to determine whether the value of the timer counter 520 has reached a specific reference. CN0 stores values related to a timer period, and may serve as a reference value needed to generate a PWM signal period.

The 1CM register (CM0) and the 2CM register (CM1) may be used to store a reference value to be compared with a value of the timer counter 520. CM0 may be used to switch the PWM signal to a high state or trigger a specific operation when the value of the timer counter 520 reaches a certain point. CM1 may be used to switch the PWM signal to a low state or perform another operation when the value of the timer counter 520 reaches another specific point. The duty cycle of the PWM signal may be determined based on the values of these two registers.

The TOM may include an output unit 510 that generates PWM signals based on the setting values of the registers. The output unit may process timer events based on the register values and generate PWM signals and transmit them to external systems. The output unit, which is a block that is designed in hardware, is controlled by the register values, and may operate in a way that ensures the accuracy and consistency of the PWM signals.

Meanwhile, the value of the 1CN register (CN0) may be used to determine the control period. When the timer value reaches the value of the 1CN register (CN0), it may be reset and start counting again from the beginning. In this method, the value of the 1CN register (CN0) in the PWM signal output module may be equal to the value of the 1CN register (CN0) in the master output module.

The second core may calculate the rising edge time value and the falling edge time value as the register values based on the switching PWM control value (e.g., duty cycle). Then, the second core may update the rising edge time value and the falling edge time value into the shadow registers. Finally, the rising edge time value stored in the shadow register may be stored in the 1CM register (CM0), and the falling edge time value may be stored in the 2CM register (CM1).

The PWM signal output module for each phase may form the rising edge of the switching PWM signal when the value of the timer counter 520 becomes equal to the value of the 1CM register (CM0), and may form the falling edge of the switching PWM signal when the value of the timer counter 520 becomes equal to the value of the 2CM register (CM1). Additionally, the timer counter 520 of the PWM signal output module for each phase may be reset in synchronization with the master PWM signal of each phase.

The second core substantially stores the rising edge time value and the falling edge time value in the shadow registers (SR registers). At the starting point of each phase's control period determined by either the timer counter 520 or the master PWM signal, these values in the shadow registers (SR registers) may be transferred to the 1CM register (CM0) and the 2CM register (CM1).

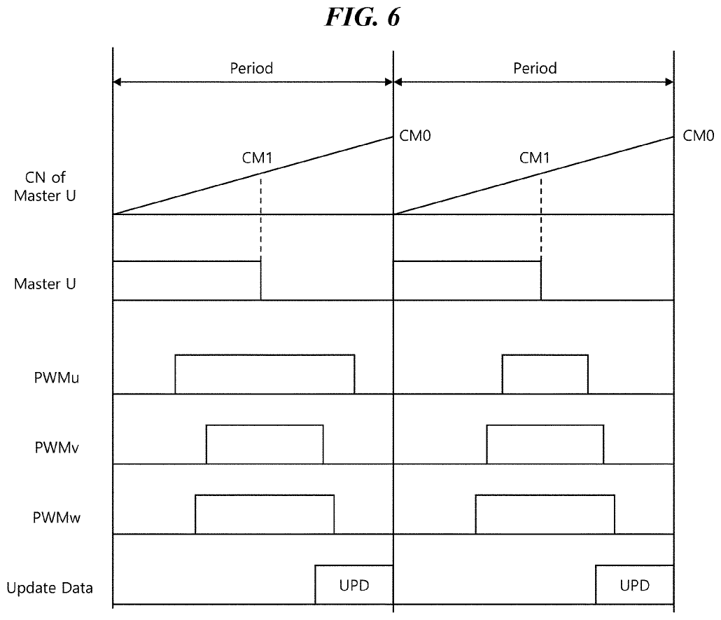

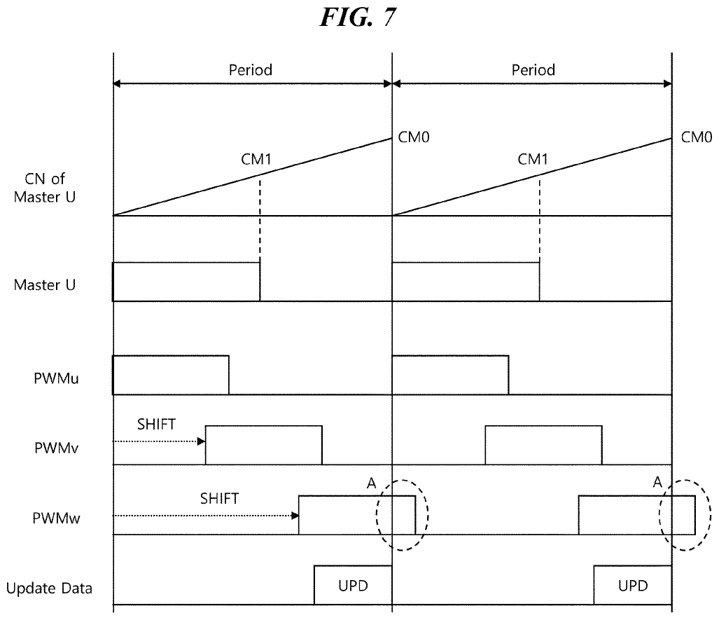

FIG. 6 is a diagram illustrating the generation of switching PWM signals for different phases without applying a phase-shifting technique, and FIG. 7 is a diagram illustrating the generation of switching PWM signals for different phases by applying a phase-shifting technique.

Referring to FIGS. 6 and 7, the inverter controller may calculate a switching PWM control value in each control period and calculate register values based on the calculated switching PWM control value. The inverter controller may then update the register values into the shadow registers before the start of the next control period (UPD). At the starting point of the next control period, the values stored in the shadow registers may be transferred to the 1CM register (CM0) and the 2CM register (CM1) of each TOM, thereby generating a master PWM signal (Master U) and switching PWM signals (PWMu, PWMv, PWMw).

This method may not present any issues when generating a switching PWM signal for each phase without applying a phase-shifting technique as shown in FIG. 6. However, when a phase-shifting technique is applied as shown in FIG. 7, errors (A) may occur in some switching PWM signals.

For example, in the case of the W-phase switching PWM signal, the control period at which the rising edge occurs and the control period at which the falling edge occurs may differ depending on the phase shift. In such a case, the control value for the current control period may be applied to the rising edge of the switching PWM signal, while the control value for the next control period may be applied to the falling edge, which may result in a problem where data consistency is not guaranteed.

To address this issue, the inverter controller according to one embodiment may generate a master PWM signal of each phase and synchronize the control period of the switching PWM signal of each phase with that of the master PWM signal generated for each phase.

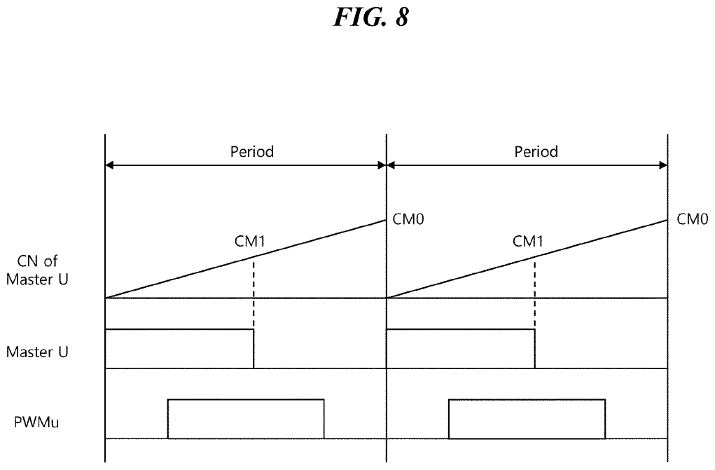

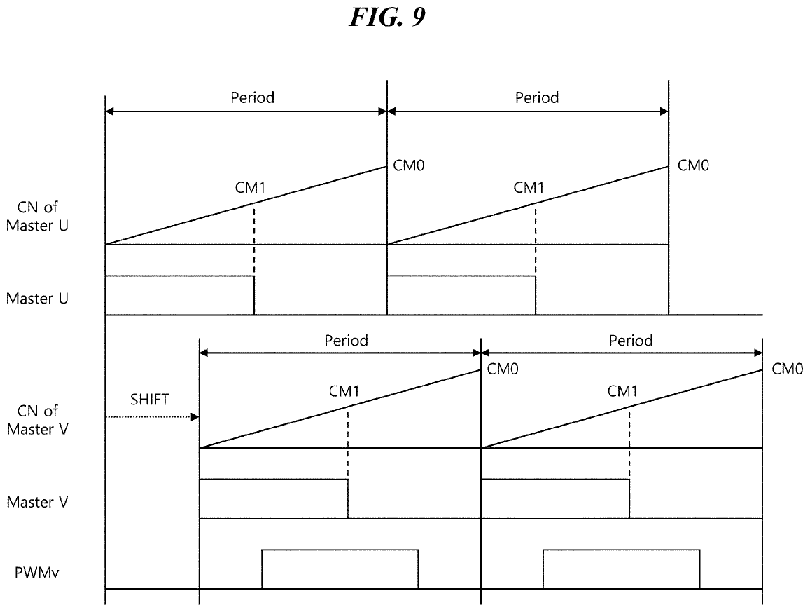

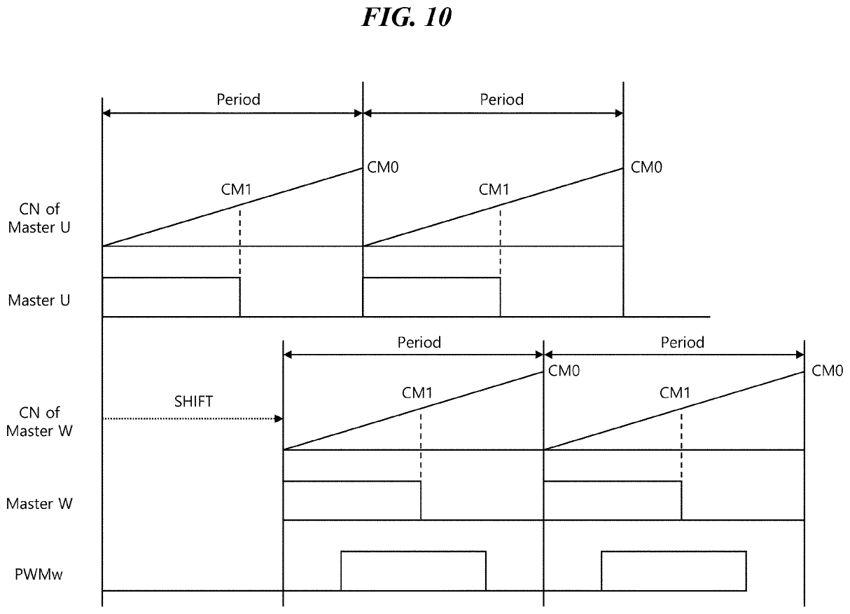

FIG. 8 is a diagram illustrating waveforms of a master PWM signal and switching PWM signal for the U phase according to one embodiment. FIG. 9 is a diagram illustrating waveforms of a master PWM signal and switching PWM signal for the V phase according to one embodiment. FIG. 10 is a diagram illustrating waveforms of a master PWM signal and switching PWM signal for the W phase according to one embodiment.

Referring to FIG. 8, the U-phase master PWM signal (Master U) may be generated, and the control period of the switching PWM signal (PWMu) may be determined according to the period of the master PWM signal (Master U).

Referring to FIG. 9, the V-phase master PWM signal (Master V) may be generated with a 120-degree phase shift from the U-phase master PWM signal (Master U). The control period of the V-phase switching PWM signal (PWMv) may then be determined according to the period of the V-phase master PWM signal (Master V).

Referring to FIG. 10, the W-phase master PWM signal (Master W) may be generated with a 240-degree phase shift from the U-phase master PWM signal (Master U). The control period of the W-phase switching PWM signal (PWMw) may then be determined according to the period of the W-phase master PWM signal (Master W).

In the example shown in FIG. 7, a problem may occur because the control period of the W-phase switching PWM signal is determined by the U-phase master PWM signal. The inverter controller according to one embodiment may determine the control period of the W-phase switching PWM signal by the W-phase master PWM signal generated separately for the W phase, thereby resolving this issue.

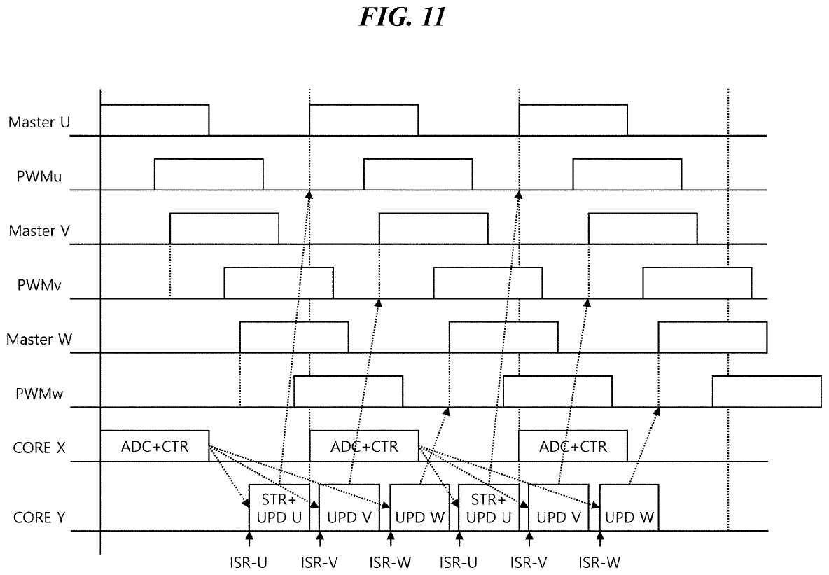

FIG. 11 is a first example diagram illustrating main waveforms of the inverter controller and the flow of an operational process of each core, according to one embodiment.

Referring to FIG. 11, the U-phase master PWM signal (Master U) may be generated according to the control period set by the first core (CORE X). Then, the U-phase switching PWM signal (PWMu) may be generated, with the control period being synchronized with that of the U-phase master PWM signal (Master U).

Then, the V-phase master PWM signal (Master V) may be generated with a certain amount of phase shift from the U-phase master PWM signal (Master U), and the V-phase switching PWM signal (PWMv) may be generated, with the control period being synchronized with that of the V-phase master PWM signal (Master V).

Then, the W-phase master PWM signal (Master W) may be generated with a certain phase shift from the V-phase master PWM signal (Master V), and the W-phase switching PWM signal (PWMw) may be generated, with the control period being synchronized with that of the W-phase master PWM signal (Master W).

The first core (CORE X) may acquire ADC sensing values (ADC) during an initial segment of the control period formed by the U-phase master PWM signal (Master U), and may calculate the switching PWM control value for each phase through a voltage control process and/or a current control process (CTR).

A U-phase ISR (ISR-U, ISR: Interrupt Service Routine) may be triggered a certain amount of time before the starting point of the next control period formed by the U-phase master PWM signal (Master U). In the U-phase ISR (ISR-U), the second core (CORE Y) may convert the switching PWM control values calculated by the first core (CORE X) into register values. Then, in the U-phase ISR (ISR-U), the second core (CORE Y) may update the register values for controlling the U-phase switching PWM signal (PWMu) (UPD U). These updated values may be applied to the registers during the next control period for the U phase.

A V-phase ISR (ISR-V) may be triggered a certain amount of time before the starting point of the next control period formed by the V-phase master PWM signal (Master V). In the V-phase ISR (ISR-V), the second core (CORE Y) may update the register values for controlling the V-phase switching PWM signal (PWMv) (UPD V). These updated values may be applied to the registers during the next control period for the V phase.

A W-phase ISR (ISR-W) may be triggered a certain amount of time before the starting point of the next control period formed by the W-phase master PWM signal (Master W). In the W-phase ISR (ISR-W), the second core (CORE Y) may update the register values for controlling the W-phase switching PWM signal (PWMw) (UPD W). These updated values may be applied to the registers during the next control period for the V phase.

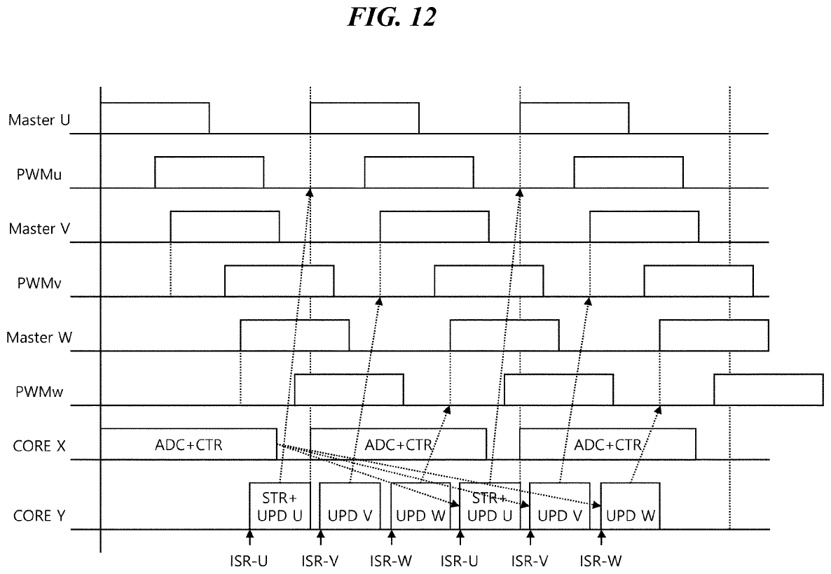

FIG. 12 is a second example diagram illustrating main waveforms of the inverter controller and the flow of an operational process of each core, according to one embodiment.

When comparing the second example shown in FIG. 12 with the first example shown in FIG. 11, the first core (CORE X) in the second example may have a higher computational load for switching PWM control values than in the first example. In other words, in the second example, the first core (CORE X) may spend more time on acquiring ADC sensing values within a control period and calculating the switching PWM control value for each phase through a voltage control process and/or a current control process.

In the second example, as the first core (CORE X) has a higher load, the calculation of the switching PWM control values may not be completed before the second core (CORE Y) updates the U-phase registers (UPD U). In this case, a conflict between the first core (CORE X) and the second core (CORE Y) may lead to a data consistency issue.

To address this issue, the inverter controller according to one embodiment may introduce a switching PWM control value flag (hereinafter referred to as a first flag).

Before calculating the switching PWM control value for each phase, the first core (CORE X) may set the first flag. For example, the first core (CORE X) may set the value of the first flag to 1.

After calculating the switching PWM control value for each phase, the first core (CORE X) may clear the first flag. For example, the first core (CORE X) may set the value of the first flag to 0.

When calculating the register values for each phase, if the first flag is set, the second core (CORE Y) may calculate the register values for each phase based on the switching PWM control value for each phase calculated in the previous control period. This can be indicated by the arrow from the first core (CORE X) to the second core (CORE Y) in the example shown in FIG. 12.

After clearing the first flag, the first core (CORE X) may store the calculated switching PWM control value for each phase in a variable for the calculated value from the previous period. The second core (CORE Y) may then check the switching PWM control value calculated in the previous control period through the variable for the calculated value from the previous period. The variable for the calculated value from the previous period and a data variable (a variable in which a switching PWM control value calculated in the current control period is stored) may be positioned in a buffer shared by the first core (CORE X) and the second core (CORE Y).

Meanwhile, when the second core (CORE Y) calculates the register values based on the variable for the calculated value from the previous period, the first core (CORE X) may have a problem with updating the variable for the calculated value from the previous period. To prevent this problem, the inverter controller according to one embodiment may introduce a register flag (hereinafter referred to as a second flag).

Before calculating the register values for each phase, the second core (CORE Y) may set the second flag. For example, the second core (CORE Y) may set the value of the second flag to 1.

After calculating the register values for each phase, the second core (CORE Y) may clear the second flag. For example, the second core (CORE Y) may set the value of the second flag to 0.

In the ISRs (ISR-U, ISR-V, ISR-W) invoked before the starting point of the control period for each phase, the second core (CORE Y) may update the registers of the PWM signal output module for each phase. In this case, in the ISR of one phase, after updating the registers of the PWM signal output module for that phase, the second core (CORE Y) may set a third flag for that phase. When the third flag for that phase is set, the second core (CORE Y) may perform the ISR of another phase with a phase difference. This helps prevent the issue of invoking ISRs for different phases in an overlapping manner. For example, it is possible to prevent the ISR-V from being performed before the ISR-U is invoked and completed.

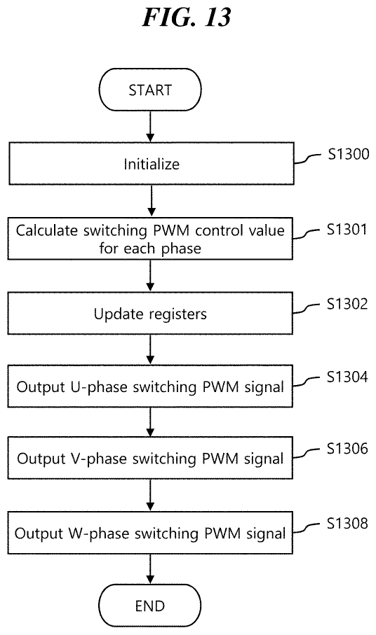

FIG. 13 is a flowchart illustrating an inverter control method according to one embodiment.

Referring to FIG. 13, the inverter controller may initialize the registers of the master output module (S1300).

Then, the first core may calculate a switching PWM control value for each phase based on ADC (Analog-to-Digital Converter) sensing values for the inverter (S1301).

Then, the second core may calculate register values for each phase based on the switching PWM control value for each phase and may update the registers of the PWM signal output modules based on the register values (S1302).

Then, the U-phase master output module may output a U-phase master PWM (Pulse Width Modulation) signal, and a U-phase PWM signal output module may output a U-phase switching PWM signal in each control period, with the control period being synchronized with that of the U-phase master PWM signal (S1304).

Then, the V-phase master output module may output a V-phase master PWM signal with a 120-degree phase difference from the U-phase master PWM signal, and the V-phase PWM signal output module may output a V-phase switching PWM signal in each control period, with the control period being synchronized with that of the V-phase master PWM signal (S1306).

Then, the W-phase master output module may output a W-phase master PWM signal with a 240-degree phase different from the W-phase master PWM signal, and the W-phase PWM signal output module may output a W-phase switching PWM signal in each control period, with the control period being synchronized with that of the W-phase master PWM signal (S1308).

Regarding a switching PWM control value flag, in step S1300, the first core may set a first flag before calculating the switching PWM control value for each phase, and may clear the first flag after the calculation. Then, in step S1302, when calculating the register values for each phase, if the first flag is set, the second core may calculate the register values for each phase based on the switching PWM control value for each phase calculated in the previous control period.

Here, the first core may store the calculated switching PWM control value for each phase in a variable for the calculated value from the previous period, after clearing the first flag, and the second core may check the switching PWM control value calculated in the previous control period through the variable for the calculated value from the previous period.

Regarding a register flag, in step S1302, the second core may set a second flag before calculating the register values for each phase, and may clear the second flag after the calculation. Then, in step S1300, the first core may calculate the switching PWM control value for each phase and may store the calculated switching PWM control value for each phase in the variable for the calculated value from the previous period. In other words, the first core may store it in the variable for the calculated value from the previous period when the second flag is cleared.

The PWM signal output module for each phase may include registers that respectively store a rising edge time value and falling edge time value of the switching PWM signal. In step S1302, the second core may calculate the rising edge time value and the falling edge time value based on the switching PWM control value for each phase.

The PWM signal output module for each phase may include a timer counter, a first register, and a second register. The rising edge time value may be stored in the first register, and the falling edge time value may be stored in the second register. When the value of the timer counter becomes equal to the value of the first register, the PWM signal output module for each phase may form the rising edge of the switching PWM signal, and when the timer counter value becomes equal to the value of the second register, it may form the falling edge of the switching PWM signal.

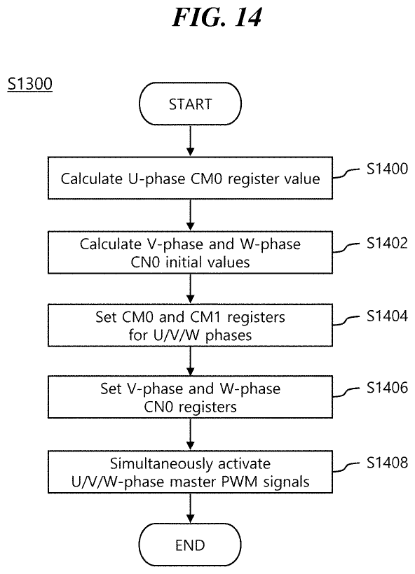

FIG. 14 is a detailed flowchart of step S1300 in the flowchart of FIG. 13.

Referring to FIG. 14, the inverter controller may calculate the value of the 1CM register (CM0) of the U-phase master output module (S1400). Here, the value of the 1CM register (CM0) may be a value corresponding to the time length of the control period. The length of the U-phase control period may be determined based on the value of the 1CM register (CM0).

The inverter controller may determine the initial values of CN0 for the V-phase and W-phase (S1402). CN0 is the value of the timer counter, and each phase may be determined according to the initial value. For example, the U-phase may have an initial value of 0, the V-phase may have a time value corresponding to a 120-degree phase difference as the initial value, and the W-phase may have a time value corresponding to a 240-degree phase difference as the initial value.

The inverter controller may set the 1CM register (CM0) and the 2CM register (CM1) so that the time length of the control period for each phase becomes equal to the control period for the U-phase and each phase has a phase difference (S1404).

The inverter controller may set the 1CN registers (CN0) for the V-phase and W-phase (S1406) and may simultaneously enable the U-phase master output module, the V-phase master output module, and the W-phase master output module to simultaneously activate the U/V/W-phase master PWM signals (S1408).

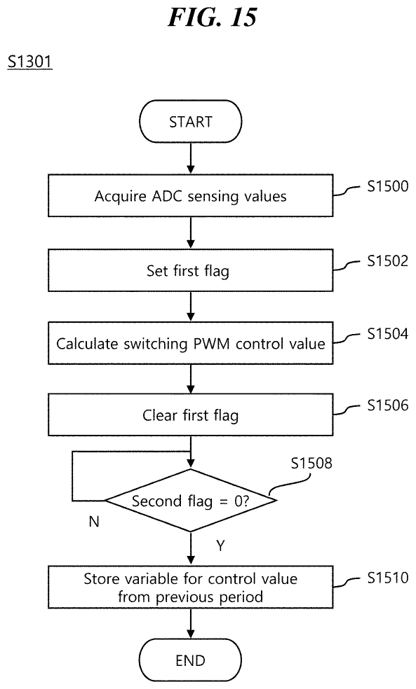

FIG. 15 is a detailed flowchart of step S1301 in the flowchart of FIG. 13.

Referring to FIG. 15, the first core may acquire ADC sensing values (S1500).

Then, the first core may set a first flag (S1502) and may calculate a switching PWM control value for each phase (S1504). After the calculation is completed, the first core may clear the first flag (S1506).

The first core may check the value of a second flag (S1508) and may wait until the value of the second flag is cleared (e.g., 0).

Then, when the second flag is cleared, the first core may store the calculated switching PWM control value in a variable for the control value from the previous period (S1510).

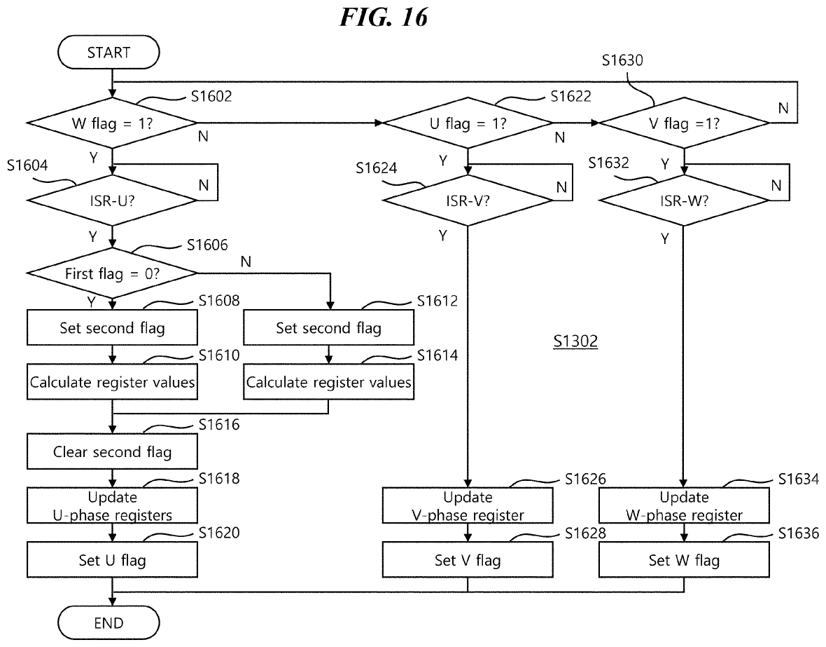

FIG. 16 is a detailed flowchart of step S1302 in the flowchart of FIG. 13.

Referring to FIG. 16, the second core may check whether a W flag is set (S1602).

If the W flag (the third flag for the W phase) is set (Y in S1602), the second core may check whether a U-phase ISR is triggered (S1604).

If the U-phase ISR is triggered (Y in S1604), the second core may check whether the first flag is cleared (S1606).

If the first flag is cleared (Y in S1606), the second core may set the second flag (S1608) and may calculate the register values for each phase based on the switching PWM control value calculated in the current control period (S1610).

If the first flag is not cleared (N in S1606), the second core may set the second flag (S1612) and may calculate the register values for each phase based on the value stored in the variable for the control value from the previous period (S1614).

Then, the second core may clear the second flag (S1616) and may update the U-phase registers (S1618). After that, the second core may set the U flag (the third flag for the U phase) and clear the W flag (S1620).

If the W flag is cleared in step S1602 (N in S1602), the second core may check whether the U flag is set (S1622).

If the U flag (the third flag for the U phase) is set (Y in S1622), the second core may check whether a V-phase ISR is triggered (S1624).

If the V-phase ISR is triggered (Y in S1624), the second core may update the V-phase registers (S1626). Then, the second core may set the V flag (the third flag for the V phase) and clear the U flag (S1628).

If the U flag is cleared in step S1622 (Nin S1622), the second core may check whether the V flag is set (S1630).

If the V flag (the third flag for the V phase) is set (Y in S1630), the second core may check whether a W-phase ISR is triggered (S1632).

If the W-phase ISR is triggered (Y in S1632), the second core may update the W-phase registers (S1634). Then, the second core may set the W flag (the third flag for the W-phase) and clear the V flag (S1636).

As described above, according to the present embodiment, the inverter can have data coherency. Furthermore, according to the present embodiment, it is possible to minimize the possibility of errors in switching PWM signals in an inverter to which a phase-shifting technique is applied.

As used herein, terms such as “include”, “comprise,” or “have” are to be interpreted as indicating the possibility of inclusion, unless explicitly stated otherwise, and therefore should not be construed as excluding other components but rather as allowing the inclusion of additional components. All terms, including technical and scientific terms, are to be interpreted as having the meanings commonly understood by those of ordinary skill in the art to which the present disclosure pertains, unless otherwise defined. Commonly used terms, such as those defined in dictionaries, should be interpreted in accordance with their contextual meaning in the relevant technical field, and unless expressly defined in the present disclosure, should not be interpreted in an idealized or overly formal sense.

The foregoing description is merely illustrative of the technical concept of the present disclosure, and those having ordinary skill in the art to which the present disclosure pertains should understand that various modifications and alterations may be made without departing from the essential characteristics of the present disclosure. Accordingly, the embodiments disclosed herein are intended to explain, not to limit, the technical concept of the disclosure, and the scope of the technical concept should not be construed as being restricted by these embodiments. The scope of protection of the present disclosure shall be interpreted based on the claims below, and all technical concepts falling within an equivalent scope shall be construed as being included within the scope of rights of the present disclosure.

What is claimed is:

1. An inverter controller comprising:
a timer module including:
master output modules configured to output master Pulse Width Modulation (PWM) signals with a phase difference, and
PWM signal output modules configured to output a switching PWM signal of each phase in each control period, with the control period being synchronized with that of the master PWM signal of each phase;
a first core configured to calculate a switching PWM control value for each phase based on Analog-to-Digital Converter (ADC) sensing values for an inverter; and
a second core configured to calculate register values for each phase based on the switching PWM control value for each phase and update registers of the PWM signal output modules based on the register values.

2. The inverter controller of claim 1, wherein the PWM signal output module for each phase includes registers that respectively store a rising edge time value and falling edge time value of the switching PWM signal, and
wherein the second core is further configured to calculate a rising edge time value and a falling edge time value based on the switching PWM control value for each phase.

3. The inverter controller of claim 2, wherein the PWM signal output module for each phase includes a timer counter, a first register, and a second register,
wherein the rising edge time value is stored in the first register, and the falling edge time value is stored in the second register, and
wherein the PWM signal output module for each phase is further configured to:
form a rising edge of the switching PWM signal when a value of the timer counter becomes equal to a value of the first register; and
form a falling edge of the switching PWM signal when the value of the timer counter becomes equal to the value of the second register.

4. The inverter controller of claim 3, wherein the timer counter of the PWM signal output module for each phase is reset in synchronization with the master PWM signal of each phase.

5. The inverter controller of claim 4, wherein the first register and the second register are updated at a starting point of each phase's control period determined by either the timer counter or the master PWM signal.

6. The inverter controller of claim 3, wherein the PWM signal output module for each phase further includes shadow registers (SR registers),
wherein the second core is further configured to store the rising edge time value and the falling edge time value in the SR registers, and
wherein the values of the SR registers are transferred to the first register and the second register at a starting point of each phase's control period.

7. The inverter controller of claim 1, wherein alternating current power with three phases is supplied to the inverter, and
wherein the power of each phase is controlled to have a 120-degree phase difference.

8. The inverter controller of claim 1, wherein the first core is further configured to set a first flag before calculating the switching PWM control value for each phase and clears the first flag after the calculation; and
wherein when calculating the register values for each phase, if the first flag is set, the second core is further configured to calculate the register values for each phase based on the switching PWM control value for each phase calculated in a previous control period.

9. The inverter controller of claim 8, wherein the first core is further configured to store the calculated switching PWM control value for each phase in a variable for the calculated value from a previous period, after clearing the first flag; and
wherein the second core is further configured to check the switching PWM control value calculated in the previous control period through the variable for the calculated value from the previous period.

10. The inverter controller of claim 1, wherein the second core is further configured to set a second flag before calculating the register values for each phase and clear the second flag after the calculation; and
wherein the first core is further configured to store the calculated switching PWM control value for each phase in a variable for the calculated value from a previous period after calculating the switching PWM control value for each phase, wherein the first core is further configured to store the calculated switching PWM control value for each phase in the variable for the calculated value from the previous period when the second flag is cleared.

11. The inverter controller of claim 1, wherein, in an Interrupt Service Routine (ISR) of each phase invoked before a starting point of the control period for each phase, the second core is further configured to update the registers of the PWM signal output module for each phase.

12. The inverter controller of claim 11, wherein, in the ISR of one phase, after updating the registers of the PWM signal output module for that phase, the second core is further configured to set a third flag for that phase, and
when the third flag for that phase is set, the second core is further configured to perform the ISR of another phase with a phase difference.

13. The inverter controller of claim 1, wherein the timer module is implemented as a generic timer module (GTM), and
wherein the master output modules and the PWM signal output modules are implemented as timer output modules (TOMs) positioned within the GTM.

14. The inverter controller of claim 1, wherein the switching PWM control value is a value that indicates a duty cycle of the switching PWM signal.

15. A control method for an inverter, the control method comprising:
calculating, by a first core, a switching Pulse Width Modulation (PWM) control value for each phase based on Analog-to-Digital Converter (ADC) sensing values for the inverter;
calculating, by a second core, register values for each phase based on the switching PWM control value for each phase;
updating, by the second core, registers of PWM signal output modules based on the register values;
outputting, by a first phase master output module, a first phase master PWM signal;
outputting, by a first phase PWM signal output module, a first phase switching PWM signal in each control period, with the control period being synchronized with that of the first phase master PWM signal;
outputting, by a second phase master output module, a second phase master PWM signal with a 120-degree phase difference;
outputting, by a second phase PWM signal output module, a second phase switching PWM signal in each control period, with the control period being synchronized with that of the second phase master PWM signal;
outputting, by a third phase master output module, a third phase master PWM signal with a 240-degree phase difference from the first phase master PWM signal; and
outputting, by a third phase PWM signal output module, a third phase switching PWM signal in each control period, with the control period being synchronized with that of the third phase master PWM signal.

16. The control method of claim 15, wherein, calculating, by the first core, the switching PWM control value for each phase comprises setting a first flag before calculating the switching PWM control value for each phase and clearing the first flag after the calculation, and
wherein calculating, by the second core, the register values for each phase comprises, when calculating the register values for each phase, if the first flag is set, calculating the register values for each phase based on the switching PWM control value for each phase calculated in a previous control period.

17. The control method of claim 16, further comprising:
storing, by the first core, the calculated switching PWM control value for each phase in a variable for the calculated value from a previous period, after clearing the first flag; and
checking, by the second core, the switching PWM control value calculated in the previous control period through the variable for the calculated value from the previous period.

18. The control method of claim 15, wherein, calculating, by the second core, the register values for each phase comprises setting a second flag before calculating the register values for each phase and clearing the second flag after the calculation, and
wherein calculating, by the first core, the switching PWM control value for each phase comprises storing the calculated switching PWM control value for each phase in the variable for the calculated value from a previous period after calculating the switching PWM control value for each phase, wherein the first core is further configured to store the calculated switching PWM control value for each phase in the variable for the calculated value from the previous period when the second flag is cleared.

19. The control method of claim 15, wherein the PWM signal output module for each phase includes registers that respectively store a rising edge time value and falling edge time value of the switching PWM signal, and
wherein calculating, by the second core, the register values for each phase includes calculating a rising edge time value and a falling edge time value based on the switching PWM control value for each phase.

20. The control method of claim 19, wherein the PWM signal output module for each phase includes a timer counter, a first register, and a second register,
wherein the rising edge time value is stored in the first register, and the falling edge time value is stored in the second register, and
wherein the control method further comprises:
forming, by the PWM signal output module for each phase, a rising edge of the switching PWM signal when a value of the timer counter becomes equal to a value of the first register; and
forming, by the PWM signal output module for each phase, a falling edge of the switching PWM signal when the value of the timer counter becomes equal to the value of the second register.
